(19) United States
(12) Patent Application Publication
(10) Pub. No.: US 2010/0299755 A1
(43) Pub. Date: Nov. 25, 2010

(54) ANTI-VIRUS/SPAM METHOD IN MOBILE RADIO NETWORKS

(75) Inventor: Matthias Roebke, Koeln (DE)

Correspondence Address: BAKER & DANIELS LLP;111 E. WAYNE STREET, SUITE 800, FORT WAYNE, IN, 46802, US

(73) Assignee: T-Mobile International AG, Bonn (DE)

(21) Appl. No.: 12/679,545

(22) PCT Filed: Sep. 13, 2008
(86) PCT No.: PCT/EP2008/007582

§ 371 Date: Jun. 25, 2010

(30) Foreign Application Priority Data
Sep. 26, 2007 (DE) 01 2007 045 909.4

(51) Int. Cl. G06F 21/00

(52) U.S. Cl. 726/24

(57) ABSTRACT

The invention concerns a process to protect against viruses/spam in mobile broadcast networks containing convergent messaging services with transmission of protocol data, characterized by having functions included in the protocol of the convergent messaging service, which facilitate the exchange of virus/spam information between the network components of one or more network operators. The invention has the objective of providing a process for convergent messaging systems that will facilitate the exchange of information regarding viruses and spam across network and platform boundaries in order to combat their widespread dissemination.

The invention concerns a process to protect against viruses/spam in mobile broadcast networks with convergent messaging services, which are undergoing standardization by the “Open Mobile Alliance,” according to the preamble of claim 1.

Computer viruses and spam (the massive transmission of messages not desired by the recipient, such as advertising) are turning into increasingly significant problems in current computer networks, such as the Internet. Operators of e-mail services or Internet service providers attempt to combat this problem by resorting to local solutions.

It may be assumed that a similar problem will also emerge increasingly in mobile broadcast networks in the future, given that the messaging services provided currently and expected for the near future (such as convergent messaging systems) in mobile broadcast networks will continue to more closely approach the functions provided by the Internet.

The problem described above is met currently by each provider or on each platform separately. However, there are no solutions that span across providers or platforms.

DE 102 26 744 B4, which originated with the same applicant, concerns a process and a device to provide a security function in the transmission of data from and to a user terminal device in a mobile communication network. A real-time analysis of the data stream to and from the user terminal device is provided in a device in a network node of the mobile communication network, where data with contents previously defined by the user or a network operator/provider are recognized and processed. As a consequence, the terminal device and any apparatus of the user linked to it will be protected against attacks from the outside. However, there is the disadvantage that the data must be specified in advance by the user or the network operator/provider to assure optimal protection. But this requires additional costly hardware/software, and in addition, it is possible that critical data (viruses/spam) are not recognized immediately and could thus propagate throughout the receiver's network and networks linked to it.

The invention has the objective of providing a process for convergent messaging systems that will facilitate the exchange of information regarding viruses and spam across network and platform boundaries in order to combat their widespread dissemination.

The objective is solved by the characteristics of Patent claim 1.

Advantageous improvements are shown in the dependent Claims.

The basic idea of the function provides for the integration of functions in the protocol of a convergent messaging service, which will facilitate the exchange of information on viruses or spam between the network components of a network operator or between several network operators.

Starting from the assumption that the various network operators will continually update information on viruses (such as virus signatures) and spam (sender lists etc.) in their network components, the invention provides for distribution of such information by means of protocol elements of the “convergent message service” to all or a subset of the partner systems (in the own network or in the networks of other operators).

The receiving systems may then decide on the basis of certain criteria, which are defined by the recipient, whether or not to integrate the information into their own virus/spam libraries.

The advantage of such a “linkage” derives from the exchange of information on spam/viruses, which makes it feasible to suppress viruses/spam in the originating network and to preclude their spread to other networks.

Furthermore, the invention also provides that the above information on spam/viruses may also be forwarded automatically by a so-called broker function to all operators linked to the function by way of appropriate protocol elements.

The invention will be described in the following by reference to graphs for a single embodiment. The graphs and their description will reveal other characteristics and advantages of the invention essential to the invention.

The graphs show:

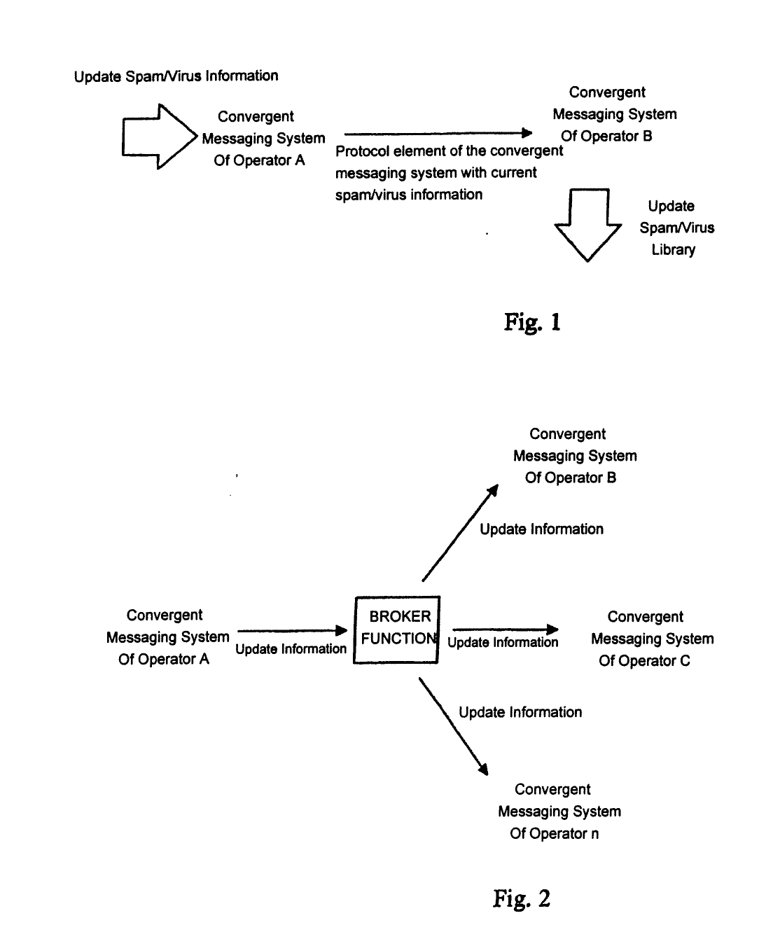

FIG. 1 the transmission of spam/virus data from a first convergent messaging system A to a second convergent messaging system B.

FIG. 2 the transmission of spam/virus data from a first convergent messaging system A to a plurality of convergent messaging systems of operators A, B, C . . . N by means of a “broker function.”

FIG. 1 shows the transmission of spam/virus data from a first convergent messaging system of operator A to a second convergent messaging system of operator B, where the transmission is handled by a protocol element of the convergent messaging service with current spam/virus information.

This spam/virus information may then be added as an update to the spam/virus database of the receiving messaging system of operator B either automatically or filtered on a specific basis.

FIG. 2 shows the transmission of spam/virus data from a first convergent messaging system of operator A to a plurality of convergent messaging systems of operators A, B, C . . . to N by means of a “broker function.”

The transmission via a protocol element of the convergent messaging service with current spam/virus information is handled by the broker function of the messaging system of operator A, which automatically sends the spam/virus information to the receiving messaging systems of operators B, C, D . . . to N. The broker function contains a more detailed definition of the messaging systems of operators B, C, D . . . to N, which receive the spam/virus information, as well as which components of the spam/virus information should be send to the particular messaging system of operators B, C, D . . . to N.

1. A process to protect against viruses/spam in mobile broadcast networks
containing convergent messaging services with transmission of protocol data,
characterized by having
functions included in the protocol of the convergent messaging service, which facilitate the exchange of virus/spam information between the network components of one or more network operators (A, B, C, . . . N).

2. The process of claim 1,
characterized by having
the various network operators (A, B, C, . . . N) update the information regarding viruses, such as virus signatures, and/or spam, such as lists of senders etc, in their network elements on a continuous basis.

3. The process of claim 1,
characterized by having
the virus and/or spam information distributed to all partner systems or a subset of the partner systems of the own network or of other operators.

4. The process of claim 1,
characterized by having
the receiving systems make the decision based on criteria determined by the recipient on whether or not to incorporate the virus and/or spam information in their own virus/spam libraries.

5. The process of claim 1,
characterized by having
the distribution of virus/spam information from the sending messaging system via broker functions of the sending messaging system handled automatically by distribution to all operators linked to the function.

6. The process of claim 2,
characterized by having
the virus and/or spam information distributed to all partner systems or a subset of the partner systems of the own network or of other operators.

7. The process of claim 2,
characterized by having
the receiving systems make the decision based on criteria determined by the recipient on whether or not to incorporate the virus and/or spam information in their own virus/spam libraries.

8. The process of claim 3,
characterized by having
the receiving systems make the decision based on criteria determined by the recipient on whether or not to incorporate the virus and/or spam information in their own virus/spam libraries.

9. The process of claim 2,
characterized by having
the distribution of virus/spam information from the sending messaging system via broker functions of the sending messaging system handled automatically by distribution to all operators linked to the function.

10. The process of claim 3,
characterized by having
the distribution of virus/spam information from the sending messaging system via broker functions of the sending messaging system handled automatically by distribution to all operators linked to the function.

11. The process of claim 4,
characterized by having
the distribution of virus/spam information from the sending messaging system via broker functions of the sending messaging system handled automatically by distribution to all operators linked to the function.
